(19) United States
(12) Patent Application Publication
(10) Pub. No.: US 2011/0167224 A1
(43) Pub. Date: Jul. 7, 2011

(54) CACHE MEMORY, MEMORY SYSTEM, DATA COPYING METHOD, AND DATA REWRITING METHOD

(75) Inventor: Takanori ISONO, Kyoto (JP)

(73) Assignee: PANASONIC CORPORATION, Osaka (JP)

(21) Appl. No.: 13/048,274

(22) Filed: Mar. 15, 2011

Related U.S. Application Data
(63) Continuation of application No. PCT/JP2009/004597, filed on Sep. 15, 2009.

(30) Foreign Application Priority Data
Sep. 17, 2008 (JP) 2008-238270

(51) Int. Cl. G06F 12/08

(52) U.S. Cl. 711/122; 711/143; 711/E12.026; 711/E12.024

(57) ABSTRACT

A cache memory according to an aspect of the present invention including entries each of which includes a tag address, line data, and a dirty flag, the cache memory includes: a command execution unit which rewrites, when a first command is instructed by a processor, a tag address included in at least one entry specified by the processor among the entries to a tag address corresponding to an address specified by the processor, and to set a dirty flag corresponding to the entry; and a write-back unit which writes, back to a main memory, the line data included in the entry in which the dirty flag is set.

### CROSS REFERENCE TO RELATED APPLICATION

This is a continuation application of PCT application No. PCT/JP2009/004597 filed on Sep. 15, 2009, designating the United States of America.

### BACKGROUND OF THE INVENTION

(1) Field of the Invention

The present invention relates to a cache memory, a memory system, a data copying method, and a data rewriting method, and particularly relates to a cache memory which includes ways and stores part of data stored in a memory.

(2) Description of the Related Art

In recent memory systems, a small-capacity and high-speed cache memory composed of a static random access memory (SRAM), for example, is provided inside or in the proximity of a microprocessor. In such a memory system, storing (cache) part of data read by the microprocessor from the main memory and part of data to be written on the main memory in the cache memory accelerates memory access by the microprocessor (for example, see Patent Literature 1: PCT international publication pamphlet No. 05/091146).

At the time of main memory access by the processor, the conventional cache memory determines whether or not the data in the address of the access destination is already stored in the cache memory, and outputs the stored data to the processor (at the time of reading), or updates the data (at the time of writing), when the data is stored in the cache memory (hereafter referred to as “hit”). In addition, when the data in the address of the access destination is not stored (hereafter referred to as “cache miss”), the cache memory stores the address and data output from the processor (at the time of writing) or reads the data in the address from the main memory and stores the data, and outputs the read data to the processor (at the time of reading).

Furthermore, in the case of cache miss, the cache memory determines whether or not there is empty space in the cache memory for storing a new address and data, and when it is determined that there is no empty space, processes such as line replacement or writing back (purge) are performed as necessary.

The cache memory also performs prefetching and touching in response to an instruction (command) from the processor. Prefetching and touching are for improving the efficiency of the cache memory (increase hit rate and reduce cache miss latency).

Prefetching is an operation for storing the data to be used in the near future in the cache memory before a cache miss occurs. Prefetching prevents cache miss on the data, allowing high-speed data reading.

Touch is an operation for securing, before the cache miss, a region in the cache memory (cache entry) for data to be rewritten in the near future. Touch prevents a cache miss when writing the data, allowing high-speed data write on the main memory.

As such, the processor can accelerate data rewriting on the main memory by instructions of a prefetch command and a touch command to the cache memory.

### SUMMARY OF THE INVENTION

However, data rewriting is more preferable.

Accordingly, it is an object of the present invention to provide a cache memory and a memory system which allow high-speed replacement of data on the main memory by the processor.

In order to achieve the object above, the cache memory according to an aspect of the present invention is a cache memory including entries each of which includes a tag address, line data, and a dirty flag, the cache memory including: a command execution unit which rewrites, when a first command is instructed by a processor, a tag address included in at least one entry specified by the processor among the entries to a tag address corresponding to an address specified by the processor, and to set a dirty flag corresponding to the entry; and a write-back unit which writes, back to a main memory, the line data included in the entry in which the dirty flag is set.

With this configuration, the processor can change the tag address stored in the cache memory with the entry specified by instructing the cache memory of the first command according to an aspect of the present invention. Thus, when copying the data in the main memory to another address using the cache memory according to an aspect of the present invention, it is possible to specify the entry in which the data in the copy source is stored, and to change the tag address from the tag address corresponding to the address of the copy source to the tag address corresponding to the address of the copy destination. Furthermore, the cache memory according to an aspect of the present invention sets the dirty flag at the same time as the update of the tag address. With this, the data in the entry whose tag address is changed is written back by performing a write-back (writing the data back to the memory) after the first command is executed. That is, the data in the copy source is copied to the address in the copy destination.

On the other hand, in the memory system using the conventional cache memory, in order to perform the similar copying operation, for example, it is necessary for the processor to read the data in the copy source stored in the cache memory and to write the read data into the memory with the address of the copy destination specified, after instructing the cache memory to perform the conventional touch (change tag address only).

As such, using the cache memory according to an aspect of the present invention allows the processor to skip the reading and writing operations. Furthermore, while the copying operation using the conventional cache memory requires two entries, the cache memory according to an aspect of the present invention can perform the copying operation with only one entry, thereby reducing the number of line replacement process in the cache memory. Thus, using the cache memory according to an aspect of the present invention allows the processor to copy the data in the main memory to another address at high speed.

Furthermore, the cache memory may include a prohibition unit which prohibits replacement of line data included in the at least one entry specified by the processor among the entries, in which, when the first command is instructed by the processor, the command execution unit rewrites the tag address included in the entry having the line data whose replacement is prohibited by the prohibition unit to the tag address corresponding to the address specified by the processor, and to set the dirty flag corresponding to the entry.

With this configuration, the processor prevents the data to be used for the copying operation from being replaced (deleted) by regular cache operations or other commands during the copying operation by locking the entry to be used for the copying operation (specifying the entry).

Furthermore, when a second command is instructed by the processor, the command execution unit may read, from the main memory, data at an address specified by the processor and to rewrite the tag address included in the at least one entry specified by the processor among the entries to a tag address corresponding to the address, and rewrite the line data included in the entry to the read data.

This configuration allows the processor to store the data whose tag address is to be rewritten with the first command in the specified entry by instructing the second command to the cache memory according to an aspect of the present invention. This allows the processor to find out the entry in which the data in the copy source is to be stored, and thus the processor can execute the first command with the entry specified.

Furthermore, when a third command is instructed by the processor, the write-back unit may write, back to the main memory, the line data included in the entry specified by the processor among the entries.

This configuration allows the processor to instruct a write-back with only the entry in which the data used for the copying operation specified by instructing the cache memory of the third command. This allows a high-speed copying operation compared to the case in which write-back is performed to all of the entries.

Furthermore, the cache memory may further include ways each including at least one of the entries, in which, when the first command is instructed by the processor, the command execution unit selects an entry included in at least one way specified by the processor among the ways, to rewrite the tag address included in the selected entry to the tag address corresponding to the address specified by the processor, and sets the dirty flag corresponding to the entry.

Furthermore, the cache memory according to an aspect of the present invention is a cache memory including entries each of which includes a tag address, line data, and a dirty flag, the cache memory including: a command execution unit which rewrites, when a fourth command is instructed by a processor, a tag address included in an entry among the entries to a tag address corresponding to an address specified by the processor, to set a dirty flag included in the entry, and to change the line data included in the entry to predetermined data; and a write-back unit which writes, back to a main memory, the line data included in the entry in which the dirty flag is set.

This configuration allows the processor to update the tag address, set the dirty flag, and update the line data, using only one command, by instructing the cache memory according to an aspect of the present invention of the fourth command. With this, the updated line data is written on an area in the memory corresponding to the tag address whose line data is updated by performing a write-back (writing the data back to the memory) after the execution of the fourth command. In other words, the predetermined data is written on the desired address.

On the other hand, in the memory system according to the conventional cache memory, in order to perform a similar writing operation, for example, it is necessary for the processor to write the data after the processor instructs the cache memory to perform the conventional touch (change only the address).

As such, using the cache memory according to an aspect of the present invention allows the processor to skip the write operation. As such, using the cache memory according to an aspect of the present invention allows the processor to rewrite the data in the main memory to the predetermined data at high speed.

Furthermore, the predetermined data may be data with bits which are all identical.

Furthermore, the memory system according to an aspect of the present invention includes a processor; a level 1 cache memory; a level 2 cache memory; and a memory, in which the level 2 cache memory is the cache memory.

According to this configuration, the cache memory according to an aspect of the present invention is applied to the level 2 cache. Here, when performing the copying operation or the writing operation using the cache memory according to an aspect of the present invention, part of the entries in the cache memory is used for the copying operation and the writing operation. As a result, there is a possibility that the processing capacity such as the regular cache operations is temporarily reduced. Here, the effect of the reduction in the processing capacity of the level 2 cache is relatively small compared to that of the level 1 cache. More specifically, when the cache memory according to an aspect of the present invention is applied to the level 1 cache, the access from the processor to the level 1 cache at the time of hit is interrupted. On the other hand, applying the cache memory according to an aspect of the present invention to the level 2 cache reduces the interruption on the access at the time of hit. In other words, applying the cache memory according to an aspect of the present invention to the level 2 cache reduces the adverse effect on the entire memory system.

Furthermore, the data copying method according to an aspect of the present invention is a data copying method for copying first data stored in a first address of a main memory to a second address of the main memory, the data copying method including: storing a tag address corresponding to the first address and the first data in a cache memory; rewriting the tag address corresponding to the first address stored in the cache memory to a tag address corresponding to the second address, and setting a dirty flag corresponding to the first data; and writing-back the first data from the cache memory to the main memory.

With this, the tag address corresponding to the first data in the copy source stored in the cache memory is changed to the tag address corresponding to the second address in the copy destination. Furthermore, the dirty flag is set at the same time as the update of the tag address. With this, the first data stored in the first address of the copy source is copied to the second address in the copy destination by performing a write-back (writing the data back to the memory).

As such, the data copying method according to an aspect of the present invention achieves the copying operation by changing the tag address in the cache memory without sending the data from the cache memory to the processor. Therefore, the data copying method according to an aspect of the present invention allows the data in the main memory to be copied to the other address at high speed.

Furthermore, the data copying method may further include prohibiting replacement of the first data stored in the cache memory in a period after the storing and before a completion of the rewriting and setting.

With this, it is possible to prevent the first data stored in the cache memory to be replaced (deleted) by the operations such as the regular cache operations.

Furthermore, the storing includes: specifying a first entry among entries included in the cache memory; and storing the tag address corresponding to the first address and the first data in the specified first entry, and the rewriting and setting includes: specifying the first entry; and rewriting the tag address corresponding to the first address included in the specified first entry to the tag address corresponding to the second address, and setting the dirty flag corresponding to the first data.

This allows the processor to find out the first entry in which the first data in the copy source is to be stored, and thus the processor can change the tag address with the first entry specified.

Furthermore, the storing may include: specifying a first entry among entries included in the cache memory; and storing, in the specified first entry, the tag address corresponding to the first address and the first data, and the writing-back includes: specifying the first entry; and writing-back the first data included in the specified entry from the cache memory to the main memory.

This allows a write-back of only the first entry used for the copying operation, instead of writing all entries back; thereby increasing the processing speed.

Furthermore, the cache memory may include ways each of which includes entries, each of the first address and the second address has a set index specifying an entry in the ways, each of the first address and the second address has the set index which is identical, and the rewriting and setting may include: specifying a way including an entry in which the first data is stored; selecting an entry specified by the set index included in the second address, among entries included in the specified way; and rewriting the tag address corresponding to the first address included in the selected entry to the tag address corresponding to the second address, and setting the dirty flag corresponding to the first data.

With this, even when entries are included in each way, having the same set index for the first address and the second address allows specifying any entry in the cache memory by only specifying the way. In other words, the processor can change the tag address in the desired entry stored in the cache memory by specifying the way.

Furthermore, the data rewriting method according to an aspect of the present invention is a data rewriting method for rewriting data stored in a first address of a main memory to predetermined first data, the data rewriting method including: rewriting a tag address included in an entry among entries included in a cache memory to a tag address corresponding to the first address, setting a dirty flag included in the entry, and changing line data included in the entry to the first data; and writing-back the first data from the cache memory to the main memory.

With this, the data rewriting method according to an aspect of the present invention achieves the update on the tag address and the operation for changing the dirty flag to the updated status, and the update on the line data at the same time. With this, the predetermined first data can be written on the first address in the main memory after the update is performed by performing a write-back (writing the data back to the memory). As described above, the data rewriting method according to an aspect of the present invention allows the data in the main memory to be rewritten with the predetermined data at high speed.

As described above, the present invention provides a cache memory, a memory system, a data copying method and a data rewriting method which allow high-speed data replacement on the main memory by the processor.

### FURTHER INFORMATION ABOUT TECHNICAL BACKGROUND TO THIS APPLICATION

The disclosure of Japanese Patent Application No. 2008-238270 filed on Sep. 17, 2008, including specification, drawings and claims is incorporated herein by reference in its entirety.

The disclosure of PCT application No. PCT/JP2009/004597 filed on Sep. 15, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 illustrates a configuration of a memory system according to an embodiment of the present invention;

FIG. 2 illustrates a configuration of a cache memory according to an embodiment of the present invention;

FIG. 3 illustrates a configuration of a way according to an embodiment of the present invention;

FIG. 4 illustrates a configuration of a command processing unit according to an embodiment of the present invention;

FIG. 5 illustrates an example of command according to an embodiment of the present invention;

FIG. 6 illustrates an example of instruction for writing data on a register according to an embodiment of the present invention;

FIG. 7 is a flowchart illustrating a flow of prefetch operation by a cache memory according to an embodiment of the present invention;

FIG. 8 is a flowchart illustrating a flow of first touch operation by a cache memory according to an embodiment of the present invention;

FIG. 9 is a flowchart illustrating a flow of second touch operation by a cache memory according to an embodiment of the present invention;

FIG. 10 is a flowchart illustrating a flow of third touch operation by a cache memory according to an embodiment of the present invention;

FIG. 11 is a flowchart illustrating a flow of write back operation by a cache memory according to an embodiment of the present invention;

FIG. 12 is a flowchart illustrating a data copying operation in a memory system according to an embodiment of the present invention;

FIG. 13 illustrates an example of data stored in a memory according to an embodiment of the present invention;

FIG. 14 illustrates a status of way after prefetching in a data copying operation according to an embodiment of the present invention;

FIG. 15 illustrates a status of way after a second touch in the data copying operation according to an embodiment of the present invention;

FIG. 16 illustrates the data stored in the memory after the data copying operation according to an embodiment of the present invention;

FIG. 17 is a flowchart illustrating a variation of a data copying operation in a memory system according to an embodiment of the present invention;

FIG. 18 is a flowchart illustrating a flow of zero-writing operation in a memory system according to an embodiment of the present invention;

FIG. 19 illustrates a status of way after a third touch in a data copying operation according to an embodiment of the present invention; and

FIG. 20 illustrates the data stored in the memory after the zero-writing operation according to an embodiment of the present invention.

### DESCRIPTION OF THE PREFERRED EMBODIMENT

The following specifically describes a memory system including a cache memory according to an aspect of the present invention with reference to the drawings.

In a memory system according to the embodiment of the present invention, the function of the cache memory (command) is extended. The processor can rewrite the data on the main memory at high speed, using the function of the cache memory.

More specifically, the cache memory according to the embodiment of the present is capable of performing a second touch which updates a dirty flag and an update of a tag address simultaneously while specifying a way. This allows a processor to select desirable data, that is, data of a copy source, among the data stored in the cache memory and to change the tag address. That is, writing back the data after the second touch on the main memory achieves high-speed data copying.

In addition, the cache memory according to the embodiment of the present invention is capable of a third touch which includes an update of the tag address, an update of the dirty flag, and an update on the line data simultaneously. With this, writing the data back to the main memory after the third touch achieves high-speed data rewriting.

First, the configuration of the memory system including the cache memory according to the embodiment of the present invention shall be described.

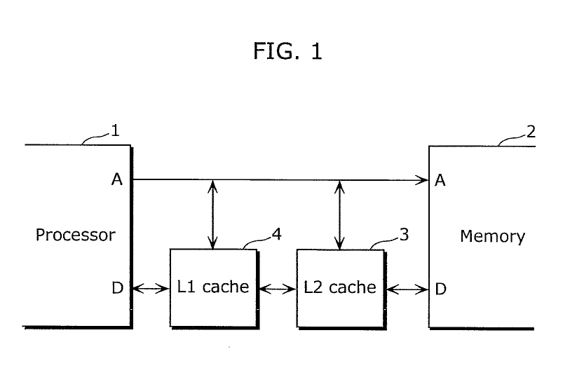

FIG. 1 illustrates a schematic configuration of the memory system according to the embodiment of the present invention. The memory system illustrated in FIG. 1 includes a processor 1, a level 1 (L1) cache 4, a level 2 (L2) cache 3 and a memory 2.

The memory 2 is a large-capacity main memory such as SDRAM.

The L1 cache 4 and the L2 cache 3 are cache memories of higher speed and less capacity compared to the memory 2. For example, the L1 cache 4 and the L2 cache 3 are SRAMs. Furthermore, the L1 cache 4 is a cache memory of higher priority arranged closer to the processor 1 than the L2 cache 3.

The L1 cache 4 and the L2 cache 3 cache data, that is, store part of data that the processor 1 reads from the memory 2 and part of data to be written on the memory 2. Here, caching is an operation which includes, when the processor 1 accesses the memory 2, the L2 cache 3 determines whether or not the data in the address of the access destination is stored in the L2 cache 3, and when the L2 cache 3 stores the data (hit), the L2 cache 3 outputs the stored data to the processor 1 (at the time of reading), or updates the data (at the time of writing). Furthermore, when the data in the address of the access destination (cache miss) is not stored in the L2 cache 3, the L2 cache 3 stores the address and data output from the processor 1 (at the time of writing), or reads the data in the address from the memory 2 and outputs the read data to the processor 1 (at the time of reading).

Furthermore, in the case of cache miss, the L1 cache 4 and the L2 cache 3 determine whether or not there is a space for storing a new address and data in the L1 cache 4 and the L2 cache 3, and when there is not space, the L1 cache 4 and the L2 cache 3 perform processing such as line replacement and writing back (purge) as necessary. Note that, detailed description of the cache operations is omitted, since it is a known technology.

The processor 1, the L1 cache 4, the L2 cache 3, and the memory 2 illustrated in FIG. 1 are typically implemented as an LSI which is an integrated circuit. They may be implemented as individual single chips, or as one chip which includes part of or all of the components. For example, the processor 1 and the L1 cache 4 may be implemented as one chip. Alternatively, each of the components may be implemented as more than one chip.

The following describes an example in which the cache memory according to an aspect of the present invention is applied to the L2 cache 3. In addition, as a specific example of the L2 cache 3, a configuration in which the present invention is applied to a 4-way set associative cache memory shall be described.

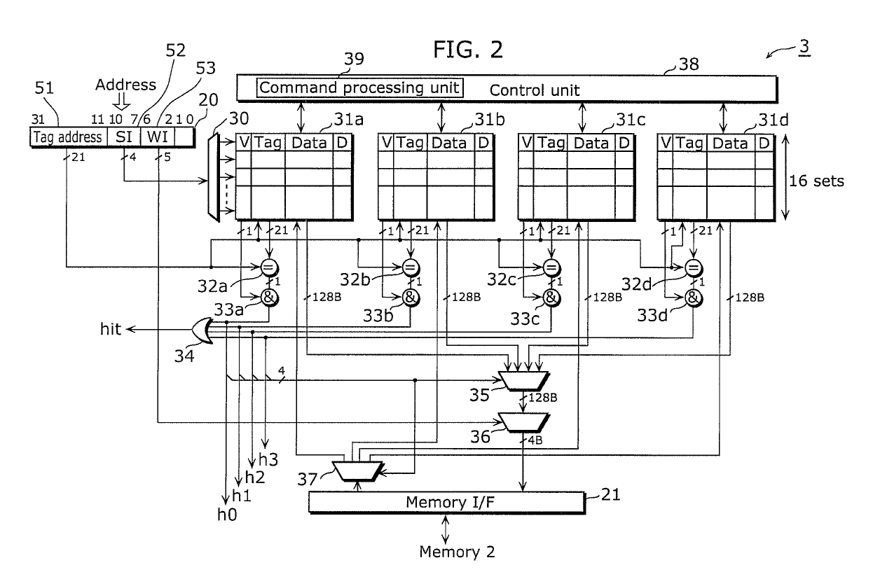

FIG. 2 is a block diagram illustrating an example of the configuration of the L2 cache 3. The L2 cache 3 illustrated in FIG. 2 includes an address register 20, a memory I/F 21, a decoder 30, four ways 31a to 31d, four comparators 32a to 32d, four AND circuits 33a to 33d, an OR circuit 34, selectors 35 and 36, a demultiplexer 37, and a control unit 38. Note that, the four ways 31a to 31d are also referred to as a way 31 when no specific distinction is necessary.

The address register 20 is a register which holds an access address to the memory 2. It is assumed that the access address is 32 bits. As illustrated in FIG. 2, the access address includes a 21-bit tag address 51, a 4-bit set index (SI) 52, and a 5-bit word index (WI) 53 in this order from the most significant bit.

Here, the tag address 51 specifies an area in the memory 2 mapped on the way 31 (the size of the area is a set count X block). The size of the area is a size determined by the address bits lower than the tag address 51 (A10 to A0), that is, 2k bytes, and is also a size of one way 31.

The set index 52 specifies one of the sets over the ways 31a to 31b. Since the set index 52 is 4 bits, the set count is 16 sets. The cache entry specified by the tag address 51 and the set index 52 is a unit for replacement, and is referred to as line data or a line when stored in the cache memory. The size of the line data is a size determined by the address bits lower than the set index 52 (A6 to A0), that is, 128 bytes. When one word is four bytes, one line data is 32 words.

The word index (WI) 53 specifies one word among words composing the line data. In addition, two least significant bits (A1, A0) in the address register 20 are ignored at the time of word access.

The memory I/F 21 is an interface for accessing the memory 2 from the L2 cache 3. More specifically, the memory I/F 21 writes data from the L2 cache 3 back to the memory 2, and loads the data from the memory 2 to the L2 cache 3.

The decoder 30 decodes 4 bits in the set index 52, and selects one of 16 sets over the four ways 31a to 31d.

The four ways 31a to 31d have the same configuration, and each way 31 has a capacity of 2k bytes.

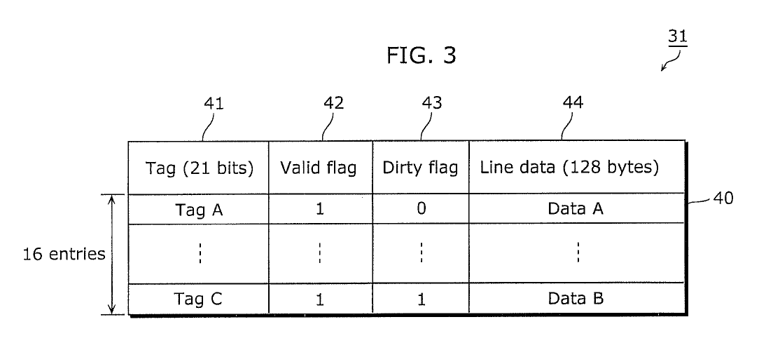

FIG. 3 illustrates the configuration of the way 31. As illustrated in FIG. 3, each way 31 has 16 cache entries 40. Each cache entry 40 includes a 21-bit tag 41, a valid flag 42, a dirty flag 43, and 128-byte line data 44.

The tag 41 is part of the address on the memory 2, and is a copy of the 21-bit tag address 51.

The line data 44 is a copy of 128-byte data in the block specified by the tag address 51 and the set index 52.

The valid flag 42 indicates whether or not the data of the cache entry 40 is valid. For example, when the data is valid, the valid flag 42 is “1”, and when the data is invalid, the valid flag 42 is “0”.

The dirty flag 43 indicates whether or not the processor 1 has written on the cache entry 40; that is, whether or not the line data 44 has been updated. In other words, the dirty flag 43 indicates whether or not writing the line data 44 back to the memory 2 is necessary, when there is the cached line data 44 in the cache entry 40 but the line data 44 differs from the data in the memory 2 due to the write by the processor 1. For example, when the line data 44 has been updated, the dirty flag 43 is “1”, and when the line data 44 has not been updated, the dirty flag 43 is “0”. Changing the dirty flag 43 to “1” is also referred to as setting the dirty flag.

The comparator 32a compares whether or not the tag address 51 in the address register 20 and the tag 41 in the way 31a in the four tags 41 included in the set selected by the set index 52 match. The same applies to the comparators 32b to 32d, except that they correspond to the ways 31b to 31d, respectively.

The AND circuit 33a compares whether or not the valid flag 42 and the comparison result by the comparator 32a match. The comparison result is referred to as h0. When the comparison result h0 is “1”, it indicates that there is line data 44 corresponding to the tag address 51 and the set index 52 in the address register 20, that is, there is a hit in the way 31a. When the comparison result h0 is 0, it indicates a cache miss. The same description applies to the AND circuits 33b to 33d, except that they correspond to the ways 31b to 31d, respectively. In other words, comparison results h1 to h3 indicate whether there is a hit or miss in the ways 31b to 31d.

The OR circuit 34 calculates OR of the comparison results h0 to h3. The results of OR is referred to as hit. Hit indicates whether or not there is a hit in the cache memory.

The selector 35 selects the line data 44 in the way 31 which is a hit, among the line data 44 in the way 31a to 31d in the selected set.

The selector 36 selects one word that is indicated by the word index 53 in the 32-word line data 44 that is selected by the selector 35.

The demultiplexer 37 outputs write data to one of the ways 31a to 31d when writing the data on the cache entry 40. The write data may be per word.

The control unit 38 controls the entire L2 cache 3. More specifically, the control unit 38 controls what is known as a cache operation that is, storing part of the data that the processor 1 reads from the memory 2 and part of the data to be written on the memory 2. The control unit 38 includes the command processing unit 39.

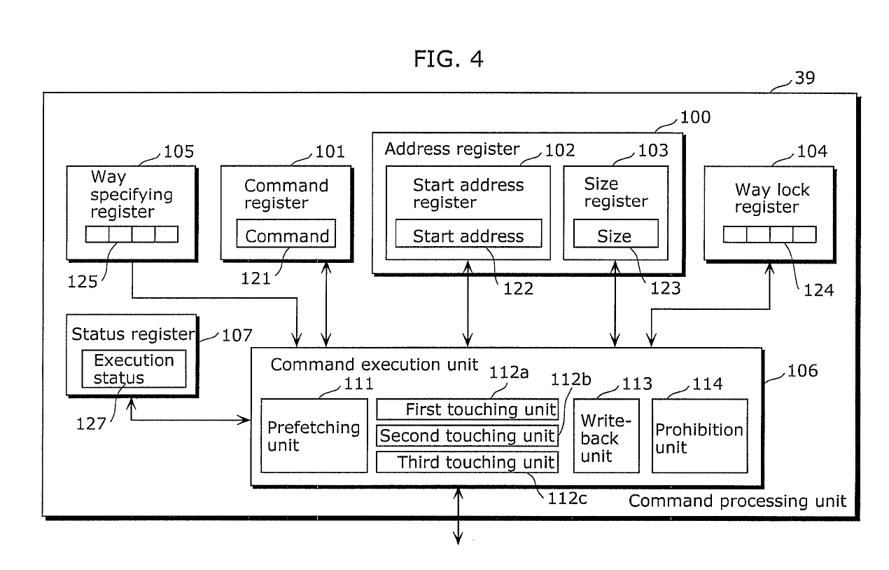

FIG. 4 illustrates the configuration of the command processing unit 39.

The command processing unit 39 executes a command specified by the processor 1. The command processing unit 39 includes an address register 100, a command register 101, a way lock register 104, a way specifying register 105, a command execution unit 106 and a status register 107.

Here, the address register 100 (the start address register 102 and the size register 103), the command register 101, the way lock register 104, and the way specifying register 105 are registers directly accessible (data can be rewritten) by the processor 1.

The command register 101 holds the command 121 specified by the processor 1.

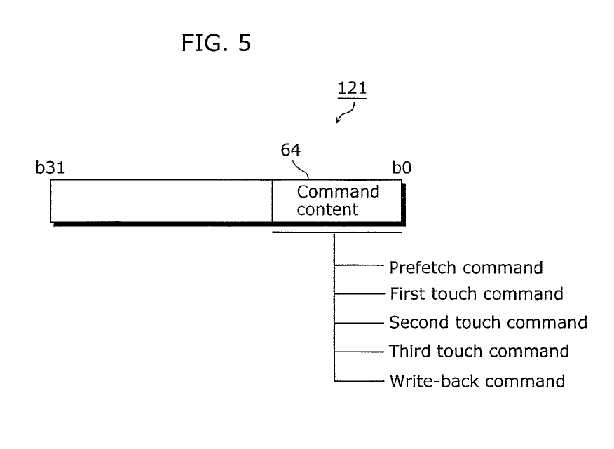

FIG. 5 illustrates an example of format of the command 121. The command 121 includes command content 64. The command content 64 refers to any of a prefetch command, a first touch command, a second touch command, a third touch command, and a write-back command.

The address register 100 holds an address range specified by the processor 1. The address register 100 includes a start address register 102 and a size register 103.

The start address register 102 holds a start address 122, which is a first address of the address range specified by the processor 1. Note that, the start address 122 may be all of the address of the memory 2 (32 bits) or part of the address. For example, the start address 122 may be an address that includes only the tag address 51 and the set index 52.

The size register 103 holds a size 123 specified by the processor 1. The size 123 indicates a size from the start address 122 to the last address of the address range. Note that, the unit of the size 123 may be a predetermined unit such as a byte count or a line count (cache entry count).

The way lock register 104 holds a lock status 124 indicating one or more ways 31 specified by the processor 1. The lock status 124 is composed of 4 bits, and each bit corresponds to one of four ways 31a to 31d, indicating whether or not the corresponding way 31 is locked. For example, the lock status 124 “0” indicates that the corresponding way 31 is not locked, while the lock status 124 “7” indicates that the corresponding way 31 is locked. Furthermore, replacement on the locked way 31 is prohibited, and the locked way 31 is not used for regular command operations and regular cache operations except specific commands.

The way specifying register 105 holds a specification status 125 indicating one or more ways 31 specified by the processor 1. The specification status 125 is composed of 4 bits each corresponds to four ways 31a to 31d, respectively. For example, the specification status 125 “0” indicates that the corresponding way 31 is not specified, while the specification status 125 “1” indicates that the corresponding way 31 is specified.

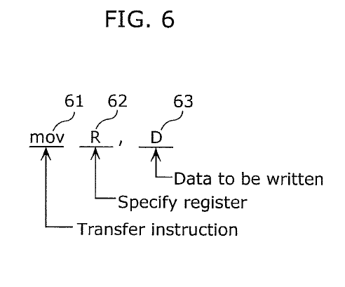

FIG. 6 illustrates an example of command for writing data on the command register 101, the start address register 102, the size register 103, the way lock register 104, and the way specifying register 105. The instruction illustrated in FIG. 6 is a regular transfer instruction (mov instruction) 61, and the register is specified by a source operand (R) 62, and the data to be stored in the register is specified as a destination operand (D) 63.

More specifically, the source operand 62 specifies the command register 101, the start address register 102, the size register 103, the way lock register 104 or the way specifying register 105, and the destination operand 63 specifies the command 121, the start address 122, the size 123, the lock status 124 or the specification status 125.

The command executing unit 106 executes a command specified by the command 121 held by the command register 101. The command executing unit 106 includes a prefetch unit 111, a first touching unit 112a, a second touching unit 112b, a third touching unit 112c, a write-back unit 113, and a prohibition unit 114.

When the prefetch command is held in the command register 101, the prefetch unit 111 performs prefetching. In addition, when the specification status 125 specifies any way 31, the prefetch unit 111 performs prefetching operation using the specified way 31.

The prefetching is an operation to read, from the memory 2, data in the address range held in the address register 100, and to store the read data in the L2 cache 3. More specifically, the prefetch unit 111 selects a cache entry 40 from cache entries 40, rewrites the tag 41 included in the selected cache entry 40 into the tag address 51 corresponding to the address range held in the address register 100, and rewrites the line data 44 included in the cache entry 40 into the read data.

The first touching unit 112 performs a first touch when the command register 101 holds a first touch command. When the specification status 125 specifies a way 31, the first touching unit 112a performs the first touch using the way 31.

The first touch here is to rewrite only the tag 41, in the same manner as the conventional touch. More specifically, the first touching unit 112a selects one cache entry 40 among the cache entries 40 included in the ways 31, and rewrites the tag 41 included in the selected cache entry 40 into the tag address 51 corresponding to the address range held in the address register 100.

The second touching unit 112b performs a second touch when the command register 101 holds a second touch command. When the specification status 125 specifies a way 31, the second touching unit 112b performs the second touch using the way 31.

The second touch here includes, in addition to the first touch, an update of the dirty flag 43 included in the selected cache entry 40 into “1”.

The third touching unit 112c performs a third touch when the command register 101 holds a third touch command. When the specification status 125 specifies a way 31, the third touching unit 112c performs the third touch using the way 31.

The third touch here includes, in addition to the second touch, an update of all of the line data 44 included in the selected cache entry 40 into “0”.

The write-back unit 113 performs a write-back when the command register 101 holds a write-back command. In addition, when the specification status 125 specifies a way 31, the write-back unit 113 performs a write-back on the specified way 31. Here, the write-back refers to writing data updated by the processor 1 among the data stored in the L2 cache 3 back to the memory 2. More specifically, the write-back unit 113 selects a cache entry 40 with a dirty flag 43 “1”, and writes the line data 44 included in the selected cache entry 40 into the address range of the memory 2 corresponding to the tag 41 included in the cache entry 40.

The prohibition unit 114 controls the way 31 used for a cache operation and command execution by the control unit 38, based on the lock status 124 held in the way lock register 104. More specifically, the prohibition unit 114 prohibits a replacement (deletion) of the line data 44 included in the way 31 with the lock status 124 “1”. The replacement is a process for storing new data, performed when all of the entries are used, and includes selecting a cache entry 40 based on a predetermined algorithm and evicting the line data 44 in the selected cache entry 40. More specifically, when the dirty flag 43 of the selected cache entry 40 is “0”, a new tag 41 and line data 44 is written on the cache entry 40. When the dirty flag 43 of the selected cache entry 40 is “1”, after the line data 44 is written back to the memory 2, a new tag 41 and line data 44 are written on the cache entry 40.

In addition, the prohibition unit 114 permits the execution of command when the specification status 125 specifies the way 31 indicated by the lock status 124.

The status register 107 holds an execution status 127 indicating whether or not the command execution unit 106 is executing a command. For example, the execution status 127 “0” indicates that the command execution unit 106 is not executing a command, and the execution status 127 “1” indicates that the command execution unit 106 is executing a command.

The operations of the L2 cache 3 according to the embodiment of the present invention shall be described.

First, prefetching shall be described. Prefetching is an operation for storing the data to be used in the near future in the cache memory before a cache miss occurs for improving the efficiency of a cache memory (increasing hit rate and reducing cache miss latency). More specifically, the L2 cache 3 stores the data in the address range specified by the processor 1.

In addition, in the L2 cache 3 according to the embodiment of the present invention, the way 31 in which the data is stored is selected based on the lock status 124 held in the way lock register 104 and the specification status 125 held in the way specifying register 105.

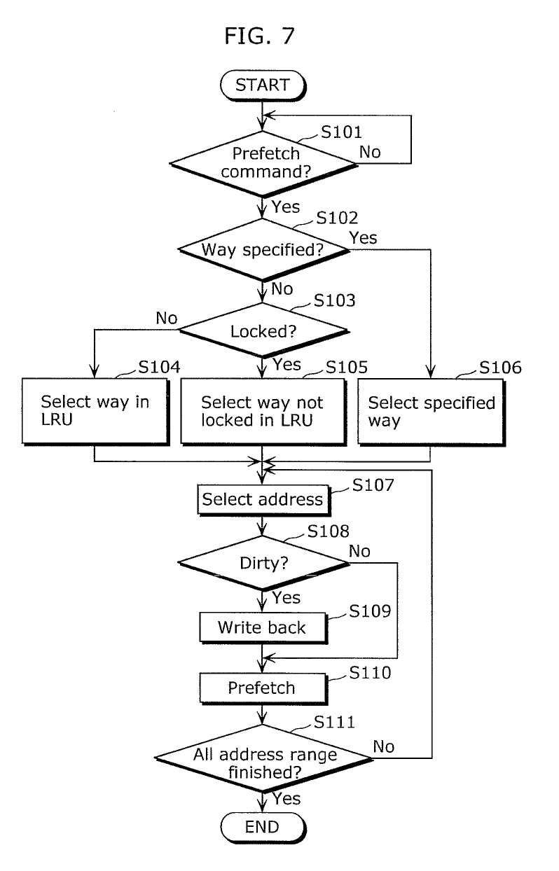

FIG. 7 is a flowchart illustrating a flow of the prefetching by the L2 cache 3.

When the command register 101 holds a prefetch command (Yes in S101), the prefetch unit 111 determines whether or not a way 31 is specified by referencing the specification status 125 held in the way specifying register 105 (S102).

When there is no way 31 is specified, that is, when all of the bits corresponding to the four ways 31a to 31d included in the specification status 125 are all “0” (No in S102), the prefetch unit 111 subsequently references the lock status 124 held in the way lock register 104 to determine whether or not the way 31 is locked (S103).

When the way 31 is not locked, that is, when all of the bits corresponding to the four ways 31a to 31d are “0”0 (No in S103), the prefetch unit 111 selects a way 31 on which the data is stored, among the four ways 31a to 31d based on the least recently used (LRU) (S104).

When the way 31 is locked, that is, when one of more of four bits included in the lock status 124 is “1” (Yes in S103), the prefetch unit 111 selects a way 31 in which the data is to be stored among non-locked (the lock status 124 being “0”) ways 31 in LRU (S105).

In addition, when the way 31 is specified, that is, when one or more of four bits included in the specification status 125 (Yes in S102), the prefetch unit 111 selects the specified (the specification status 125 being “1”) way 31 as the way 31 to which the data is to be stored (S106).

Next, the prefetch unit 111 performs prefetching using the way 31 selected in step S104, S105 or S106.

First, the prefetch unit 111 selects an address for performing prefetching, using the start address 122 held in the start address register 102 and the size 123 held in the size register 103 (S107). More specifically, the prefetch unit 111 determines an address range from the start address 122 and ranging size 123 as an address range to be prefetched, and prefetches the data in the address range to be prefetched per 128 bytes.

Next, the prefetch unit 111 checks the dirty flag 43 in the cache entry 40 included in the way 31 selected in step S104, S105 or S106, and specified by the set index 52 of the address selected in step S107 (S108).

When the dirty flag 43 is “1” (Yes in S108), the prefetch unit 111 performs a write-back (S109).

When the dirty flag 43 is “0” (No in S108), or after the write-back (S109), the prefetch unit 111 reads the data in the address range selected in step S107 from the memory 2, and stores the data in the way 31 selected in step S104, S105 or S106 (S110). More specifically, the prefetch unit 111 updates the tag 41 into the tag address 51 in the address range selected in step S107, updates the line data 44 in the data read from the memory 2, sets the valid flag 42 to “1”, and sets the dirty flag 43 to “0”.

Furthermore, when not all of the data in the address range from the start address 122 ranging size 123 is prefetched (No in S111), the prefetch unit 111 selects the address range of 128 bytes (S108), repeatedly performs the process identical to the process after step S108 described above to the selected address range until all of the data is prefetched (Yes in S111).

As described above, the L2 cache 3 according to the embodiment of the present invention is capable of performing a prefetch using the way 31 specified by the processor 1 by holding the specification status 125 written by the processor 1.

Furthermore, the L2 cache 3 according to the embodiment of the present invention prohibits an update (replacement) of the way 31 specified by the processor 1, by holding the lock status 124 written by the processor 1.

The first touch operation by the L2 cache 3 shall be described below.

The touch is to secure a cache entry 40 in advance for data which is to be rewritten in the near future before a cache miss, in order to improve the efficiency of the cache memory (increase hit rate and reduce cache miss latency). More specifically, the L2 cache 3 secures a cache entry 40 for storing the data in the address range specified by the processor 1.

Furthermore, in the L2 cache 3 according to the embodiment of the present invention, the way used for the touch is selected based on the lock status 124 held by the way lock register 104 and the specification status 125 held by the way specifying register 105.

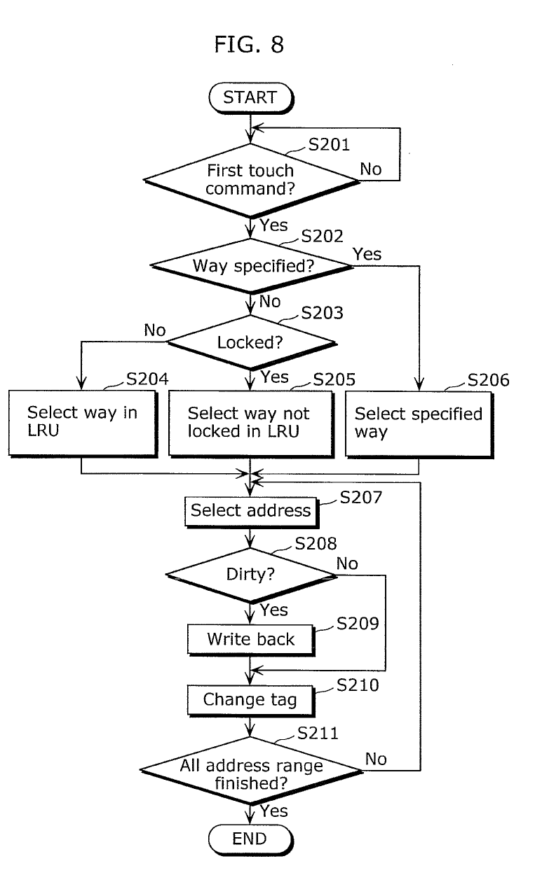

FIG. 8 is a flowchart illustrating a flow of the first touch by the L2 cache 3.

When the first touch command is held in the command register 101 (Yes in S201), the first touching unit 112a determines whether or not the way 31 is specified with reference to the specification status 125 held in the way specifying register 105 (S202).

When the way 31 is not specified, that is, when all of the bits corresponding to the four ways 31a to 31d are “0” (No in S202), the first touching unit 112a determines whether or not the way 31 is locked with reference to the lock status 124 held in the way lock register 104 (S203).

When the ways 31 are not locked, that is, when all of the bits corresponding to the four ways 31a to 31d are “0” (No in S203), the first touching unit 112a selects a way 31 used for the touch among the four ways 31a to 31d (S204).

On the other hand, when the way 31 is locked, that is, when one or more of the four bits included in the lock status 124 are “1” (Yes in S203), the first touching unit 112a selects a way 31 used for the touch among ways that are not locked (the lock status 124 being “0”) in LRU (S205).

Alternatively, when the way 31 is specified, that is, when one or more of the four bits included in the specification status 125 is “1” (Yes in S202), the first touching unit 112a selects the specified (the specification status 125 being “1”) way 31 as a way 31 used for the touch (S206).

Next, the first touching unit 112a performs the first touch using the way 31 selected in step S204, S205, or S206.

First, the first touching unit 112a selects an address on which the touch is performed, using the start address 122 held in the start address register 102 and the size 123 held in the size register 103 (S207). More specifically, the first touching unit 112a determines an address range from the start address 122 ranging size 123 as an address range subject to the touch, and performs the touch on the address range per address unit corresponding to 128-byte data. Subsequently, the first touching unit 112a checks the dirty flag 43 of the cache entry 40 included in the way 31 selected in step S204, S205, or S206, and specified by the set index 52 in the address selected in step S207 (S208).

When the dirty flag 43 is “1” (Yes in S208), the first touching unit 112a performs write-back (S209).

When the dirty flag 43 is “0” (No in S208), or after the write-back (S209), the first touching unit 112a updates the tag 41 of the cache entry 40 included in the way 31 selected in step S204, S205, or S206 and specified by the set index 52 of the address selected in step S207 (S210). More specifically, the first touching unit 112a updates the tag 41 to the tag address 51 corresponding to the address selected in step S207, sets the valid flag 42 to “1”, and sets the dirty flag 43 to “0”.

When touch on the address range from the start address 122 ranging size 123 is not finished (No in S211), the first touching unit 112a then selects an address corresponding to 128-byte data (S208), repeatedly performs the process identical to the process after S208 (S208 to S210) on the selected address until touch on all of the address range is finished (Yes in S211).

As described above, the L2 cache 3 according to the embodiment of the present invention is capable of performing a touch using the way 31 specified by the processor 1 by holding the specification status 125 written by the processor 1.

Furthermore, the L2 cache 3 according to the embodiment of the present invention prohibits an update of the way 31 specified by the processor 1, by holding the lock status 124 written by the processor 1.

Next, the second touch shall be described. The second touch is an operation for updating the dirty flag 43, in addition to the first touch (update of tag 41).

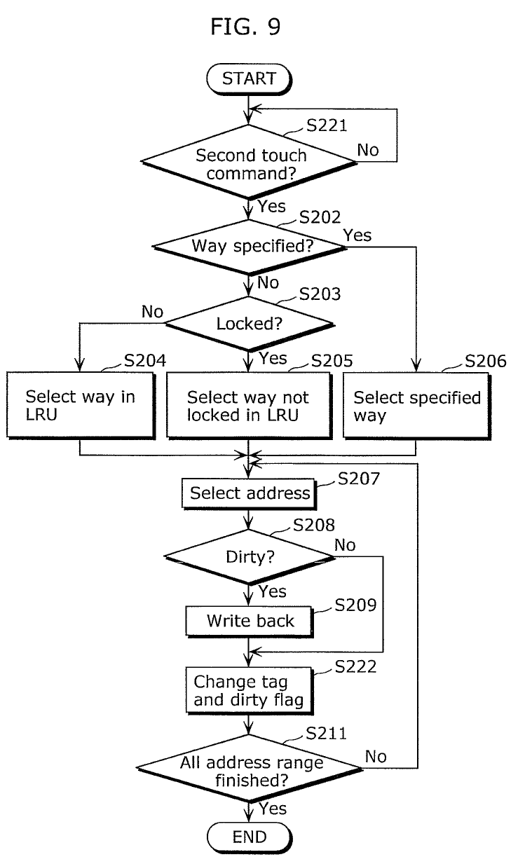

FIG. 9 is a flowchart illustrating a flow of the first touch by the L2 cache 3.

Note that, the process illustrated in FIG. 9 differs from the first touch operation illustrated in FIG. 8 in that steps S221 and S222 are included. Note that, the other process is similar to that of the first touch operation illustrated in FIG. 8. Thus, the following only describes the difference. In addition, although the process illustrated in FIG. 8 is executed by the first touching unit 112a, the process illustrated in FIG. 9 is performed by the second touching unit 112b.

When the command register 101 holds the second touch command (Yes in S221), the second touching unit 112b performs the process similar to the process after step S202 described above.

In addition, when the dirty flag 43 is “0” (No in S208) or after the write-back (S209), the second touching unit 112b updates the tag 41 and the dirty flag 43 which are included in the way 31 selected in step S204, S205, or S206 and included in the cache entry 40 specified by the set index 52 of the address selected in step S207 (5222). More specifically, the second touching unit 112b updates the tag 41 to the tag address 51 of the address range selected in step S207, sets the valid flag 42 to “1”, and sets the dirty flag 43 to “1”.

Next, the third touch shall be described. The third touch is an operation including, in addition to the second touch (update of the tag 41 and the dirty flag 43), updating all of the line data 44 to “0”.

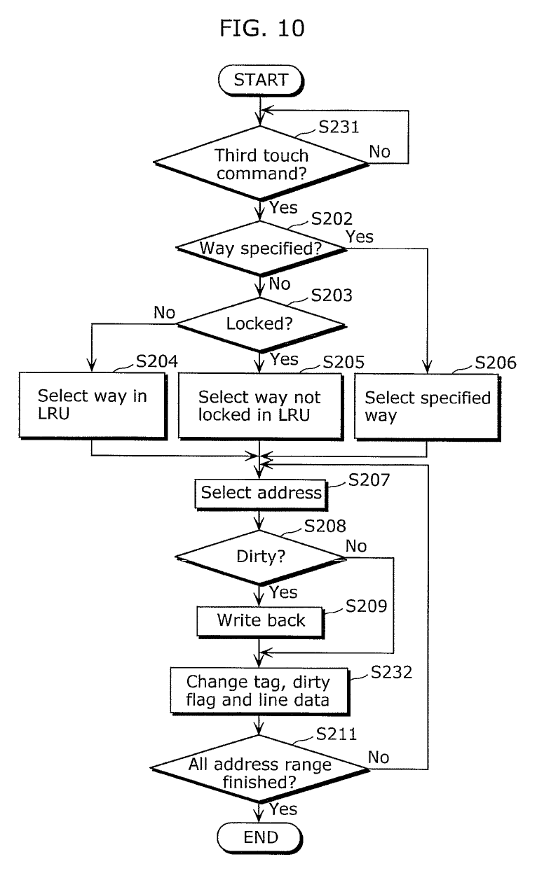

FIG. 10 is a flowchart illustrating a flow of the third touch by the L2 cache 3.

Note that, the process illustrated in FIG. 10 differs from the first touch operation illustrated in FIG. 8 in that the process in steps S231 and S232 are different. Note that, the other process is similar to that of the first touch operation illustrated in FIG. 8. Thus, the following only describes the difference. In addition, although the process illustrated in FIG. 8 is executed by the first touching unit 112a, the process illustrated in FIG. 10 is performed by the third touching unit 112c.

When the command register 101 holds the third touch command (Yes in S231), the third touching unit 112c performs the process similar to the process after step S202 described above.

In addition, when the dirty flag 43 is “0” (No in S208) or after the write-back (S209), the third touching unit 112c updates the tag 41, the dirty flag 43, and the line data 44 which are included in the way 31 selected in step S204, S205, or S206 and included in the cache entry 40 specified by the set index 52 of the address selected in step S207 (S232). More specifically, the third touching unit 112c updates the tag 41 to the tag address 51 of the address range selected in step S207, updates all of the bits included in the line data 44 to “0”, sets the valid flag 42 to “1”, and sets the dirty flag 43 to “1”.

The following describes the write-back operation. The write-back is an operation for writing the line data 44 with the dirty flag 43 “1” into the memory 2. That is, the write-back is an operation of writing the data updated in the cache memory back to the memory 2.

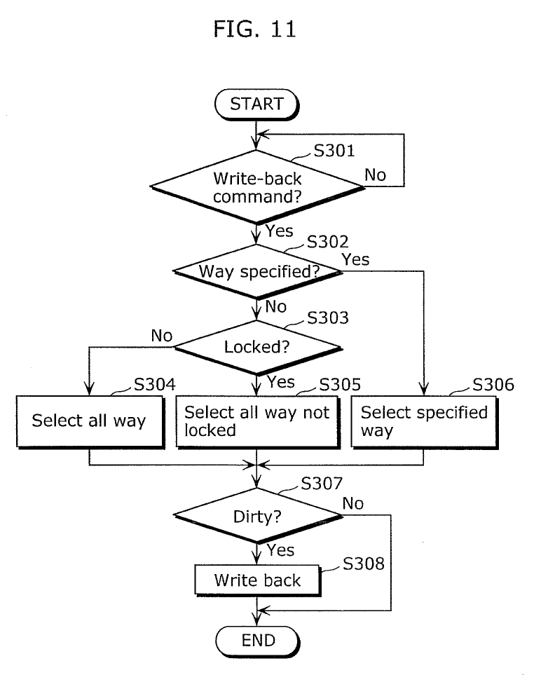

FIG. 11 is a flowchart illustrating a flow of the write-back by the L2 cache 3.

When the command register 101 holds a write-back command (Yes in S301), the write-back unit 113 determines whether or not the way 31 is specified with reference to the specification status 125 held in the way specifying register 105 (S302).

When there is no way 31 is specified, that is, when all of the bits corresponding to the four ways 31a to 31d included in the specification status 125 are all “0” (No in S302), the write-back unit 113 subsequently determines whether or not the way 31 is locked with reference to the lock status held in the way lock register 104 (S303).

When the ways 31 are not locked, that is, when all of the bits corresponding to the four ways 31a to 31d are “0” (No in S303), the write-back unit 113 selects all of the ways 31a to 31d as the ways subject to write-back (S304).

On the other hand, when the way 31 is locked, that is, when one or more of the four bits included in the lock status 124 are “1” (Yes in S303), the write-back unit 113 selects all of the ways that are not locked (the lock status 124 being “0”) as the ways subject to write-back (S305).

Alternatively, when the way 31 is specified, that is, when one or more of the four bits included in the specification status 125 is “1” (Yes in S302), the write-back unit 113 selects the specified (the specification status 125 being “1”) way 31 as a way subject to write-back (S306).

Subsequently, the write-back unit 113 performs a write-back on the way 31 selected in step S304, S305, or S306.

First, the write-back unit 113 checks the dirty flag 43 of each cache entry 40 included in the way 31 selected in step S304, S305, or S306 (S307).

After that, the write-back unit 113 writes back the cache entry 40 with the dirty flag 43 “1”, that is, Yes in S307 (S308). More specifically, the write-back unit 113 writes the line data 44 of the cache entry 40 with the dirty flag 43 “1” back to the memory 2, and changes the dirty flag 43 to “0”.

The write-back unit 113 does not write back the cache entry 40 with the dirty flag 43 “0” (No in S307).

As described above, the L2 cache 3 according to the embodiment of the present invention is capable of performing write-back using the way 31 specified by the processor 1 by holding the specification status 125 written by the processor 1.

Furthermore, the L2 cache 3 according to the embodiment of the present invention prohibits an update of the way 31 specified by the processor 1, by holding the lock status 124 written by the processor 1.

The following describes operation for copying the data in the memory 2 to another address in the memory 2 in the memory system according to the embodiment of the present invention.

In the memory system according to the embodiment of the present invention, the processor 1 can copy the data in the memory 2 to another address using the function of the L2 cache 3 described above.

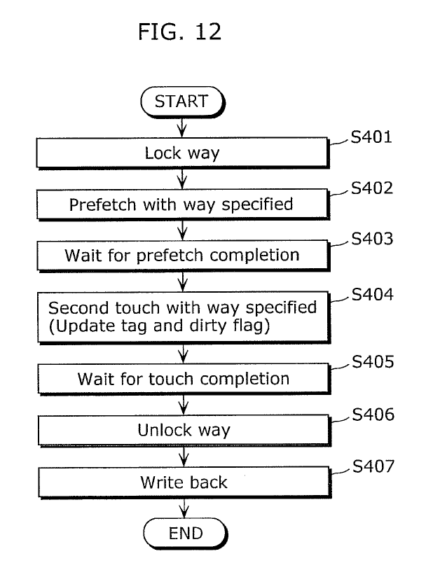

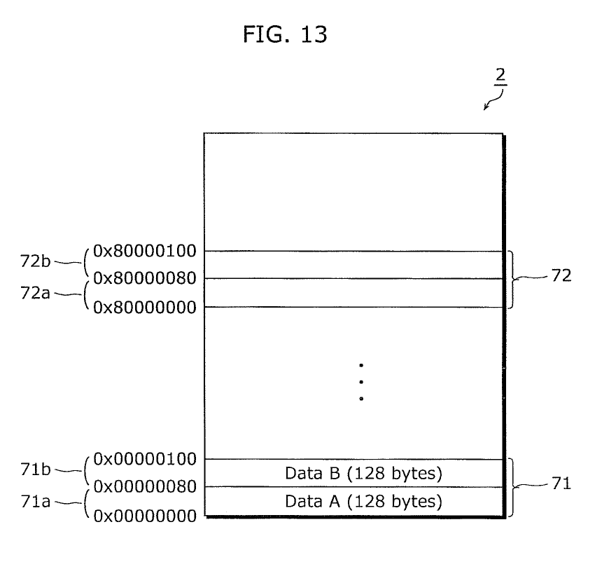

FIG. 12 is a flowchart illustrating the flow of a data copying operation in the memory system according to the embodiment of the present invention. FIG. 13 illustrates an example of data stored in the memory 2.

The following illustrates an example of copying 256-byte data in the address range 71 (0×00000000 to 0×00000100) to the address range 72 (0×80000000 to 0×800000100). It is assumed that the way 31a is used for the copying.

First, the processor 1 instructs the L2 cache 3 to lock the way 31a (S401). More specifically, the processor 1 locks the way 31 by writing “0,0,0,1” on the way lock register 104. Note that, the 4-bit lock status 124 held in the way lock register 104 corresponds to the ways 31a to 31d from the lowest bit.

Next, the processor 1 specifies the way 31a and instructs the L2 cache 3 to prefetch the data of the copy source (S402). More specifically, the processor 1 writes a prefetch command on the command register 101, the start address (0×00000000) on the start address register 102, the size (0×100) on the size register 103, and “0, 0, 0, 1” on the way specifying register 105. With this, the L2 cache 3 stores the data in the address range 71 in the memory 2 in the way 31a. Note that, here, the 4-bit specification status 125 held in the way specifying register 105 corresponds to the ways 31a to 31d from the lowest bit.

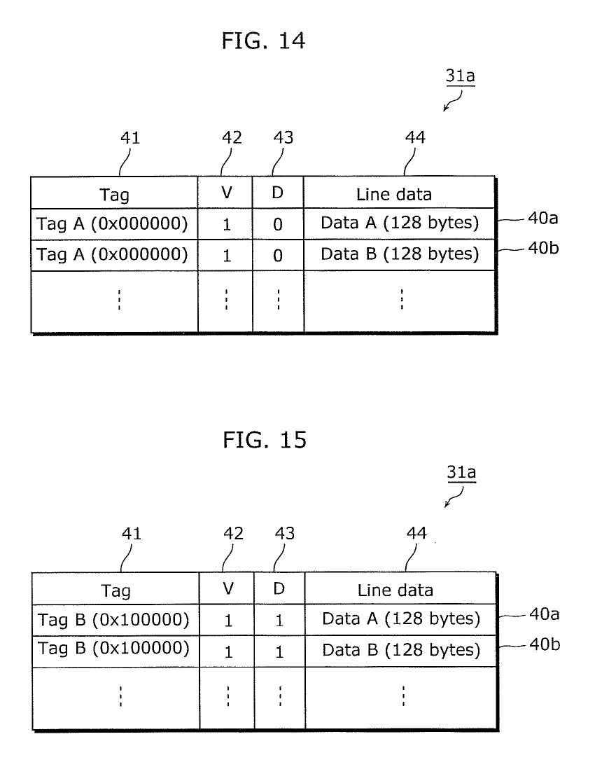

FIG. 14 illustrates the status of the way 31a after prefetch is performed in step S402. As illustrated in FIG. 14, the L2 cache 3 stores, in the cache entries 40a and 40b, the data A and the data B stored in the address range 71 in the memory 2.

Here, the cache entry 40a corresponds to the set index 52 “0000” of the address range 71a in which the data A is stored, and the cache entry 40b corresponds to the set index 52 “0001” of the address range 71b in which the data B is stored. Furthermore, both the L2 cache 3 stores, in the tags 41 of the cache entries 40a and 40b, the tag A (0×000000) which is the tag address 51 of the address range 71. Furthermore, the L2 cache 3 sets the valid flags 42 of the cache entry 40a and 40b to “1”, and sets the dirty flags 43 to “0”.

Next, the processor 1 waits for the completion of the prefetch operation by the L2 cache 3 (S403). More specifically, the processor 1 determines the completion of the prefetch operation by checking the execution status 127 held in the status register 107.

After the prefetch operation by the L2 cache 3 is completed, the processor 1 specifies the way 31a and instructs the L2 cache 3 to perform the second touch operation on the address of the copy destination (S404). More specifically, the processor 1 writes the second touch command on the command register 101, the start address (0×80000000) on the start address register 102, the size (0×100) on the size register 103, and “0, 0, 0, 1” on the way specifying register 105. With this, the L2 cache 3 sets the tags 41 and the dirty flags 43 of the cache entries 40a and 40b in the way 31a in which the data is stored in step 5402.

FIG. 15 illustrates the status of the way 31a after the second touch is performed in step S403. As illustrated in FIG. 15, the L2 cache 3 updates the tags 41 of the cache entries 40a and 40b to the tag B (0×100000) which is the tag address 51 of the address range 72 which is the copy destination. In addition, the L2 cache 3 sets the dirty flags 43 of the cache entries 40a and 40b to “1”.

As described above, in the memory system according to the embodiment of the present invention, specifying a way 31 allows the change of the tag 41 with the data in the copy source stored in the L2 cache 3 specified. In other words, the second touch with the way 31 specified changes the address of the data in the copy source to the address of the data in the copy destination.

Subsequently, the processor 1 waits for the completion of the second touch operation by the L2 cache 3 (S405). More specifically, the processor 1 determines whether or not the second touch operation is complete by checking the execution status 127 held in the status register 107.

After the completion of the second touch operation by the L2 cache 3, the processor 1 then unlock the way 31a (S406). More specifically, the processor 1 unlocks the way 31a by writing “0, 0, 0, 0” on the way lock register 104.

Next, the processor 1 instructs the L2 cache 3 to perform the write-back operation (S407). More specifically, the processor 1 writes the write-back command on the command register 101. With this, the L2 cache 3 writes the data A and the data B on the address range 71 corresponding to the tag B updated in step S404. More specifically, the L2 cache 3 writes, on the memory 2, the line data 44 included in the cache entry 40 with the dirty flag 43 “1”. Here, according to the embodiment of the present invention, the second touch operation (S404) sets the dirty flag 43 to “1”, together with an update of the tag 41. Thus, the data is copied to the address range 72 corresponding to the updated tag 41 by performing the write-back after the second touch operation (S404).

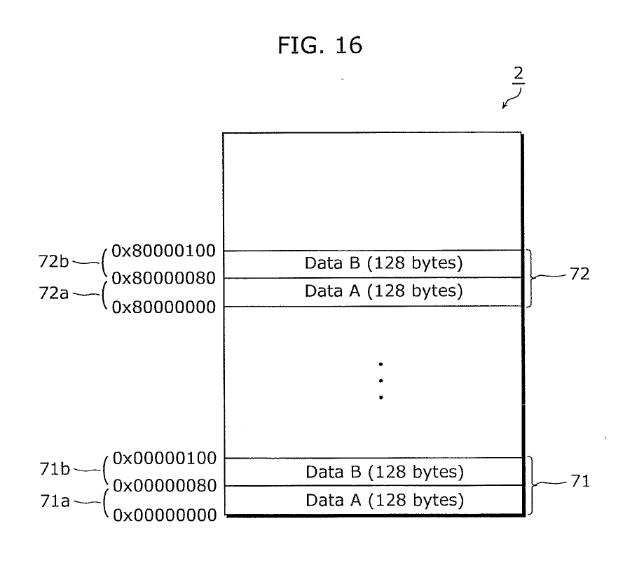

FIG. 16 illustrates the data stored in the memory 2 after the write-back operation (S407). As illustrated in FIG. 16, with the process illustrated in FIG. 12, the data A and the data B stored in the address range 71 (71a and 71b) are copied to the address range 72 (72a and 72b).

As described above, in step S404, the processor 1 changes the tag 41 of the desired cache entry 40 stored in the L2 cache 3 by sending a second touch command specifying the way 31a to the L2 cache 3.

Here, as illustrated in the example described above, it is necessary for the address range 71 which is the copy source and the address range 72 which is the copy destination to have the same set index 52. This is because, in the set-associative cache memory, the set index 52 determines a cache entry 40 to be used in the way 31. In other words, it is necessary to specify the way 31 and the set index 52 for uniquely selecting any of the cache entries 40 included in the L2 cache 3.

Thus, the processor 1 can perform the touch operation (updating the tag 41) with the cache entries 40a and 40b in which the data in the address range 71 stored in the L2 cache 3 is stored by specifying the way 31 using the specification status 125 and specifying an address range having the same set index 52 as the address range 71 which is the copy source and the address range 72 of the copy destination.

With this, according to the embodiment of the present invention, it is possible to copy data at high speed using the touch.

Furthermore, in the second touch, the dirty flag 43 is updated to “1” at the same time as the update of the tag 41. With this, the data in the cache entry with a changed tag 41 is written back by performing a write-back after the execution of the second touch. In other words, the data in the address area corresponding to the tag address before changing the address is copied to the address area corresponding to the tag address after the change.

On the other hand, in the memory system using the conventional cache memory, for example, the processor 1 has to cause the cache memory to prefetch the data in the copy source, reads the prefetched data in the copy source from the cache memory, causes the cache memory to perform the first touch (change only the tag 41) on the address of the copy destination, writes the read data in the copy source to the cache memory with the address of the copy destination specified, and instructs the cache memory to perform a write-back, in order to perform a similar copy operation.

As described above, using the L2 cache 3 allows the processor 1 to omit the read operation and the write operation. Furthermore, with the conventional copy method, when copying 128-byte data, it is necessary to use two cache entries 40. In contrast, according to the copying method of the present invention, only one cache entry 40 is necessary to perform the copying. With this, the number of line replacement process in the L2 cache 3 can be reduced. As described above, using the L2 cache 3 according to the embodiment of the present invention allows the processor 1 to copy the data in the memory 2 to another address at high speed.

Furthermore, in the memory system according to the embodiment of the present invention, the way 31a used for copying the data is locked in step S401. With this, it is possible to prevent the data in the way 31a used for copying the data is deleted or updated by a regular cache operation or another command during the data copying.

Furthermore, in the memory system according to an embodiment of the present invention, the data in the copy source is stored in the L2 cache 3 by a prefetch specifying the way 31a in step S402. With this, the processor 1 can find out the way 31a in which the data in the copy source is stored. Thus, the processor 1 can specify the way 31a and send the second touch command to the L2 cache 3.

Note that, the process after step S404 may be performed on the data to which the regular prefetch is performed or that has already been stored, after locking the way 31 (S401), without performing the prefetching with the way 31a specified.

In addition, although the write-back (S407) is performed after the way is unlocked (S406) in FIG. 12, the write-back may be performed with the way 31a specified.

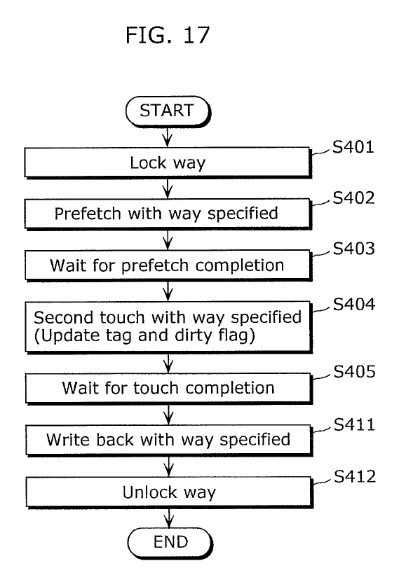

FIG. 17 is a flowchart illustrating the flow of a data copying operation in the memory system according to a variation of the embodiment of the present invention.

As illustrated in FIG. 17, after the second touch operation by the L2 cache 3 is complete (after S405), the processor 1 instructs the L2 cache 3 to perform a write-back with the way 31a specified (S411). More specifically, the processor 1 writes the write-back command on the command register 101, and writes “0, 0, 0, 1” on the way specifying register 105. With this, the L2 cache 3 writes the data A and the data B on the address range 71 corresponding to the tag B updated in step S404. More specifically, the L2 cache 3 writes, on the memory 2, the line data 44 included in the cache entry 40 with the dirty flag 43 “1” included in the way 31a.

Next, the processor 1 unlocks the way 31a (S412). In the process illustrated in FIG. 17 also allows the copying of the data A and the data B stored in the address range 71 on the address range 72 in the same manner as the process illustrated in FIG. 12. Furthermore, the write-back is performed with only the way 31a specified. Thus, compared to a case where the write-back is performed on all of the ways 31, it is possible to shorten the process time.

Furthermore, the write-back may also be performed with the way 31a specified in step S407 illustrated in FIG. 12.

Furthermore, in step S407 illustrated in FIG. 12, the L2 cache 3 performed a write-back based on the write-back command written by the processor 1. However, instead of the command from the processor 1, the data in the cache entries 40a and 40b may be written on the memory 2 with a write-back performed at the time of regular cache operation or a write-back performed at the time of executing command (the prefetch command or the first to third touch).

The following describes an operation for rewriting the data in the address range specified by the memory 2 into “0” (hereafter referred to as zero-writing operation) in the memory system according to the embodiment of present invention shall be described.

In the memory system according to the embodiment of the present invention, the processor 1 can rewrite the data in the address range specified by the memory 2 into “0” using the function of the L2 cache 3 described above.

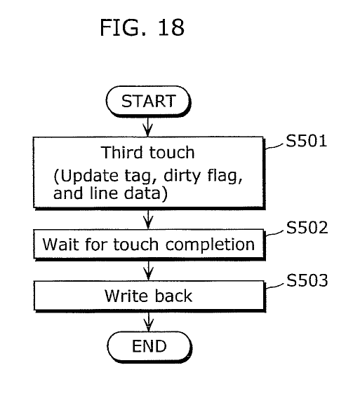

FIG. 18 is a flowchart illustrating the flow of the zero-writing operation in the memory system according to the embodiment of the present invention.

The following describes an example in which all of the 256-byte data in the address range 71 illustrated in FIGS. 13 (0×00000000 to 0×00000100) to “0”.

First, the processor 1 instructs the L2 cache 3 to perform the third touch operation (S501). More specifically, the processor 1 writes the third touch command on the command register 101, the start address (0×00000000) on the start address register 102, the size (0×100) on the size register 103. With this, the L2 cache 3 performs the touch on the address corresponding to the address range 71, updates the dirty flag 43, and updates all of the line data 44 to “0”. Note that, it is assumed that the way 31a is specified as a way 31 used for the third touch.

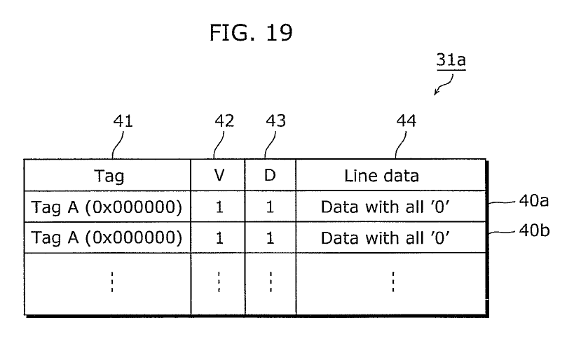

FIG. 19 illustrates the status of the way 31a after the third touch is performed in step S501. As illustrated in FIG. 19, the L2 cache 3 updates the tags 41 of the cache entries 40a and 40b to the tag A (0×000000) which is the tag address 51 in the address range 71. Furthermore, the L2 cache 3 sets dirty flags 43 of the cache entries 40a and 40b to “1”, and rewrites all of the line data 44 to the data with all “0”.

Subsequently, the processor 1 waits for the completion of the third touch operation by the L2 cache 3 (S502). More specifically, the processor 1 determines whether or not the third touch operation is complete by checking the execution status 127 held in the status register 107.

After the completion of the third touch by the L2 cache 3, the processor 1 instructs the L2 cache 3 to perform the write-back operation (S503). More specifically, the processor 1 writes the write-back command on the command register 101. With this, the L2 cache 3 writes the data with all “0” on the address range 71 corresponding to the tag A updated in step S501. More specifically, the L2 cache 3 writes, on the memory 2, the line data 44 included in the cache entry 40 with the dirty flag 43 “1”. Here, according to the embodiment of the present invention, the third touch operation (S501) sets the dirty flag 43 to “1”, together with an update of the tag 41. Thus, the data with all “0” is written on the address range 71 corresponding to the tag 41 that is set by performing the write-back after the third touch operation (S501).

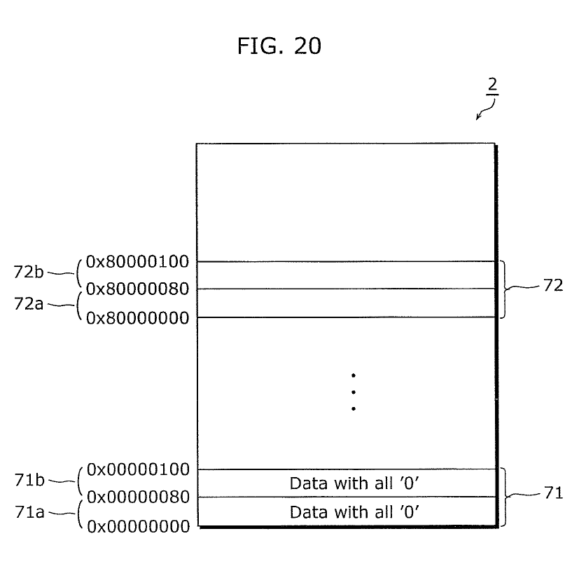

FIG. 20 illustrates the data stored in the memory 2 after the write-back operation (S503). As illustrated in FIG. 20, the process illustrated in FIG. 18 rewrites all of the data in the address range 71 to “0”.

As described above, the L2 cache 3 according to the embodiment of the present invention updates the tag 41, the dirty flag 43, and the line data 44 at the same time by the third touch. With this, after the third touch is executed, the updated line data 44 is written on the address range 71 corresponding to the updated tag 44 by performing the write-back.

On the other hand, in the memory system using the conventional cache memory, in order to perform the same write operation, for example, the processor 1 causes the cache memory to perform the first touch on the address which is the write destination (change only the tag 41), and writes the data with all “0” to the cache memory with the address of the write destination specified, and instructs the cache memory to perform the write-back.

As described above, using the L2 cache 3 allows the processor 1 to omit the write operation. Thus, using the L2 cache 3 according to an aspect of the present invention allows the processor 1 to write all of the data in the memory 2 to “0” at high speed.

Note that, in the description above, the L2 cache 3 updates all of the line data 44 to “0” at the time of the third touch operation. However, all If the line data 44 may be updated to the data with all “1”. To put it differently, the L2 cache 3 may update the line data 44 to the data with all predetermined identical bits at the time of the third touch operation. Furthermore, the L2 cache 3 may update the line data 44 to the data with mixed data “0” and “1” at the time of third touch.

Furthermore, the third touch with the way 31 specified may also be performed in step S501. Furthermore, in step S503, the write-back may be performed with the way 31 used for the third touch specified. Furthermore, when performing the third touch with the way 31 specified, the third touch using the locked way 31 (S501) may be performed after locking the way 31.

The above description describes cache memory according to the embodiment of the present invention. However, the present invention is not limited to the embodiment.

For example, in the description above, an example in which the cache memory according to an aspect of the present invention is applied to the L2 cache 3. However, the cache memory according to an aspect of the present invention may be applied to the L1 cache 4.

Here, when performing the copying operation or the writing operation using the L2 cache 3, part of the storage area in the L2 cache 3 is used for the copying operation or the writing operation. Thus, there is a possibility that the processing capacity of the regular cache operations temporarily decreases. Here, the effect of the reduction in the processing capacity of the level 2 cache is relatively small compared to level 1 caches. More specifically, when the cache memory according to an aspect of the present invention is applied to the L1 cache 4, the access of the L1 cache 4 from the processor 1 at the time of hit is interrupted. On the other hand, applying the cache memory according to an embodiment of the present invention to the L2 cache 3 reduces the interruption on the access at the time of hit. In other words, applying the cache memory according to an aspect of the present invention to the level 2 cache reduces the adverse effect on the entire memory system.

In addition, in the description above, the memory system with the L2 cache 3 and the L1 cache 4 is used as an example. However, the present invention is applicable to the memory system including only the L1 cache 4.

Furthermore, the present invention may be applied to the memory system with a level 3 cache or more. In this case, for the reason described above, it is preferable to apply the cache memory according to an aspect of the present invention to the largest level. Furthermore, in the description above, the address register 100 holds the start address 122 and the size 123. However, the address register 100 may hold an end address which is the last address of the address range in the command object instead of the size 123. In other words, the address register 100 may include, instead of the size register 103, an end address register to which the processor 1 specifies the end address.

In addition, the address register 100 may hold a specified address instead of the address range. Here, the specified address may be an address on the memory 2, or part of the address on the memory 2 (for example, the tag address 51 and the set index 52, or only the tag address).

Furthermore, in the description above, an example in which the LRU is used as an algorithm for determining the replacement destination of the lines is described. However, other algorithms such as Round-Robin or Random may also be used.

In addition, in the description above, the processor 1 rewrites the lock state 124 held in the way lock register 104. However, the way lock command may also be provided. More specifically, when the processor 1 writes the way lock command on the command register 101, the prohibition unit 114 may update the lock status 124. Note that, when the way lock command is used, the prohibition unit 114 may lock the predetermined way 31, or the lock command may include information for specifying the way 31.

Furthermore, in the description above, in the prefetch operation and the first to the third touch operations, the L2 cache 3 specifies the way 31 and performs the prefetch operation, the first to third touch operations, and the write back operation when one or more of the four bits included in the specification status 125 held by the way specifying register 105. However, the regular prefetch command, the regular first to third touch commands, the regular write-back command, the way-specifying prefetch command, the way-specifying first to third touch commands, and the way-specifying write-back command may be separately provided. More specifically, the L2 cache 3 may perform the processing using the way 31 specified by the specification status 125 only when the way-specifying command is written on the command register 101, and may select a way 31 used for the processing regardless of the specification status 125 when a regular command is written on the command register 101.

In addition, in the description above, the specification is performed per way 31 by the specification status 125. However, the specification may be performed per one or more cache entries 40 included in the way. To put is differently, at the time of the copying operation, the second touch may be performed with the entry in which the data in the copy source is stored specified.

Furthermore, in the description above, the lock is performed per way 31 by the lock status 124. However, the lock may also be performed per one or more cache entries 40 included in the way.

In addition, in the description above, the L2 cache 3 includes the way lock register 104 which holds the lock status 124. However, each of the cache entries 40 may include the lock flag similar to the valid flag 42 and the dirty flag 43, and the control unit 38 may determine whether or not the entry is locked by checking the lock flag.

Furthermore, in the description above, the locked way 31 is not used at the time of regular cache operation and the regular command operation. However, the locked way 31 may be used for operations where there is no replacement. More specifically, the locked way 31 may be used for the operations such as the operations at the time of read-hit in the regular cache operations.

Furthermore, the above description is made using an example of the cache memory with the 4-way set associative L2 cache 3.

However, the number of the ways 31 may be other than four. Furthermore, the present invention may be applicable to a full-associative cache memory. More specifically, each of the ways 31 may include only one cache entry 40. In this case, merely specifying the way 31 uniquely selects the desired cache memory 40 included in the L2 cache 3. Thus, there is no limit on the address range 72 of the copy destination at the time of data copying operation (the limit of the identical set index 52), and the data may be copied to a desired address range at high speed.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention is applicable to a cache memory and a memory system which includes a cache memory.

What is claimed is:

1. A cache memory including entries each of which includes a tag address, line data, and a dirty flag, said cache memory comprising:
a command execution unit, when a first command is instructed by a processor, configured to rewrite a tag address included in at least one entry specified by the processor among the entries to a tag address corresponding to an address specified by the processor, and to set a dirty flag corresponding to the entry; and
a write-back unit configured to write, back to a main memory, the line data included in the entry in which the dirty flag is set.

2. The cache memory according to claim 1, further comprising
a prohibition unit configured to prohibit replacement of line data included in the at least one entry specified by the processor among the entries,
wherein, when the first command is instructed by the processor, said command execution unit is configured to rewrite the tag address included in the entry having the line data whose replacement is prohibited by said prohibition unit to the tag address corresponding to the address specified by the processor, and to set the dirty flag corresponding to the entry.

3. The cache memory according to claim 1,
wherein, when a second command is instructed by the processor, said command execution unit is configured to read, from the main memory, data at an address specified by the processor and to rewrite the tag address included in the at least one entry specified by the processor among the entries to a tag address corresponding to the address, and to rewrite the line data included in the entry to the read data.

4. The cache memory according to claim 1,
wherein, when a third command is instructed by the processor, said write-back unit is configured to write, back to the main memory, the line data included in the entry specified by the processor among the entries.

5. The cache memory according to claim 1, further comprising
ways each including at least one of the entries,
wherein, when the first command is instructed by the processor, said command execution unit is configured to select an entry included in at least one way specified by the processor among the ways, to rewrite the tag address included in the selected entry to the tag address corresponding to the address specified by the processor, and to set the dirty flag corresponding to the entry.

6. A cache memory including entries each of which includes a tag address, line data, and a dirty flag, said cache memory comprising:
a command execution unit, when a fourth command is instructed by a processor, configured to rewrite a tag address included in an entry among the entries to a tag address corresponding to an address specified by the processor, to set a dirty flag included in the entry, and to change the line data included in the entry to predetermined data; and
a write-back unit configured to write, back to a main memory, the line data included in the entry in which the dirty flag is set.

7. The cache memory according to claim 6,
wherein the predetermined data is data with bits which are all identical.

8. A memory system comprising:
a processor;
a level 1 cache memory;
a level 2 cache memory; and
a memory,
wherein said level 2 cache memory is the cache memory according to claim 1.

9. A data copying method for copying first data stored in a first address of a main memory to a second address of the main memory, said data copying method comprising:
storing a tag address corresponding to the first address and the first data in a cache memory;
rewriting the tag address corresponding to the first address stored in the cache memory to a tag address corresponding to the second address, and setting a dirty flag corresponding to the first data; and
writing-back the first data from the cache memory to the main memory.

10. The data copying method according to claim 9, further comprising
prohibiting replacement of the first data stored in the cache memory in a period after said storing and before a completion of said rewriting and setting.

11. The data copying method according to claim 9,
wherein said storing includes:
specifying a first entry among entries included in the cache memory; and
storing the tag address corresponding to the first address and the first data in the specified first entry, and
said rewriting and setting includes:
specifying the first entry; and
rewriting the tag address corresponding to the first address included in the specified first entry to the tag address corresponding to the second address, and setting the dirty flag corresponding to the first data.

12. The data copying method according to claim 9,
wherein said storing includes:
specifying a first entry among entries included in the cache memory; and
storing, in the specified first entry, the tag address corresponding to the first address and the first data, and
said writing-back includes:
specifying the first entry; and
writing-back the first data included in the specified entry from the cache memory to the main memory.

13. The data copying method according to claim 9,
wherein the cache memory includes ways each of which includes entries,
each of the first address and the second address has a set index specifying an entry in the ways,
each of the first address and the second address has the set index which is identical, and
said rewriting and setting includes:
specifying a way including an entry in which the first data is stored;
selecting an entry specified by the set index included in the second address, among entries included in the specified way; and
rewriting the tag address corresponding to the first address included in the selected entry to the tag address corresponding to the second address, and setting the dirty flag corresponding to the first data.

14. A data rewriting method for rewriting data stored in a first address of a main memory to predetermined first data, said data rewriting method comprising:
rewriting a tag address included in an entry among entries included in a cache memory to a tag address corresponding to the first address, setting a dirty flag included in the entry, and changing line data included in the entry to the first data; and
writing-back the first data from the cache memory to the main memory.
